(19) United States
(12) Patent Application Publication
(10) Pub. No.: US 2011/0156501 A1
(43) Pub. Date: Jun. 30, 2011

(54) RECIPROCATING POWER GENERATING MODULE

(75) Inventors: WEN-YANG PENG, Hsinchu County (TW); Chung-Ping Chiang, Taipei County (TW); Chan-Hsing Lo, Hsinchu County (TW)

(73) Assignee: Industrial Technology Research Institute, Hsinchu (TW)

(21) Appl. No.: 13/042,061

(22) Filed: Mar. 7, 2011

Related U.S. Application Data
(63) Continuation-in-part of application No. 12/055,218, filed on Mar. 25, 2008.

(30) Foreign Application Priority Data
Dec. 11, 2007 (TW) 096147149

(51) Int. Cl. H02K 35/02

(52) U.S. Cl. 310/28

(57) ABSTRACT

A reciprocating power generating module is disclosed, which comprises: a guide having a hollow space along the center axis thereof; an integrated magnet composed of a plurality of magnetic elements which are aligned one next to another in a manner such that poles of each of the magnetic elements are orientated to repel poles of its neighboring magnetic elements; and a coil composed of a plurality of at-least-two-phase windings which are wound around the guide and integrated one winding next to another; wherein the integrated magnet and the coil are arranged in a manner such that the coil is received in the hollow space inside the guide, and the shape of the inner surface of the guide directs the motion path of the integrated magnet.

This application is a continuation-in-part of the pending application with application Ser. No. 12/055,218 filed on Mar. 25, 2008.

### FIELD OF THE INVENTION

The present disclosure relates to a reciprocating power generation module, and more particularly, to a reciprocating power generation module, being an integrated unit composed of a plurality of magnets and a multi-cell coil in a manner that the plural magnets are connected with each other for orientating poles of any one of the plural magnets to repel poles of its neighboring magnets.

### BACKGROUND OF THE INVENTION

Electrical generators will find a wide application in all fields of technology. Following the call for less use of batteries, the development for having a compact and highly efficient electrical generator is in high demand. Generally, the compact-sized electrical generator is used as the power supply for portable electronic devices. However, for the proliferation of compact portable electrical generators, it is crucial that those compact portable electrical generators should be able to generate electricity with sufficient capacity in a limited space and can be manufactured with a reasonable cost. Such miniature power generator can be manufactured small enough to be received inside wearable objects at the positions such as inside a bag of clothing, being embedded in the shoe sole of a shoe, being mounted on eyeglasses or received inside a watch, etc., so that it can be used as an emergency power source for devices such as a flash light, a radio, communications devices, and so on.

Reciprocating dynamo flashlights have been available on the market for a conceivable period of time, but for its lack of adequate power generating efficiency, it had been determined to be impractical in usage. In terms of the movement of movers that is performed in an electromagnetic power generator, the driving mode of the electromagnetic power generator can be categorized into three different types which are continuous rotary, swing, and the reciprocating types. Among which, the reciprocating type is the least used even when the linear reciprocating motion is the most direct form of power transmission in many applications since it usually requires to be converted into a rotation motion through a certain mechanism and thus causes the whole system to have poor performance. For those currently available compact-sized reciprocating power generators using magnets as movers, each of which will require to have a stroke that is more than twice the length of its solenoid so as to affecting the same with various magnetic flux. In addition, the power generating efficiency of those conventional compact-sized reciprocating power generators is poor since the design adopted thereby with respect to the arrangement of the magnetic field lines and the way that the coil is being wound enables the polarity direction of the magnet to be parallel to the axis of its solenoid.

Please refer to FIG. 1, which shows a conventional reciprocating dynamo flashlight. As shown in FIG. 1, the conventional reciprocating dynamo flashlight only can achieve its maximum power generation when the magnets 10 are moved to the positions corresponding to the two ends of the coils 12. It is known that the flux density at the two ends of a magnet is not going to increase drastically when it achieves a certain thickness. Therefore, even by serially connecting a plurality of such power generating modules together, it will only cause the volume to increase but not the energy density, so that the sensitivity of the whole power generating device with respect to the external kinetic energy will not be increased.

Thus, it is required to have an improved reciprocating power generating module that is able to design an innovated magnet arrangement for shorting the moving path of magnets inside its coil and thus achieving higher magnetic flux density utilization. Because of the voltage output of a reciprocating power generator is in direct proportion to the product of the moving speed of magnet and the change rate of magnet flux with respect to position variation, the reciprocating power generating module will be able to achieve a high density multi-pole flux path by orientating poles of any one of its magnets to repel poles of its neighboring magnets, and be able to increase its induced electromotive force by increase the change rate of magnet flux with respect to position variation of its coil.

### SUMMARY OF THE INVENTION

The present disclosure provides a reciprocating power generating module, capable of achieving high magnetic flux density utilization and high coil density by cooperation between the magnetic arrangement of the magnets used thereby and the way that the coil is being wound.

According to one aspect of the present disclosure, one embodiment provides a reciprocating power generating module comprising: a guide having a hollow space along the center axis thereof; an integrated magnet composed of a plurality of magnetic elements which are aligned one next to another in a manner such that poles of each of the magnetic elements are orientated to repel poles of its neighboring magnetic elements; and a coil composed of a plurality of at-least-two-phase windings which are wound around the guide and integrated one winding next to another; wherein the integrated magnet and the coil are arranged in a manner such that the coil is received in the hollow space inside the guide, and the shape of the inner surface of the guide directs the motion path of the integrated magnet.

According to another aspect of the present disclosure, another embodiment provides a reciprocating power generating module comprising: a coil composed of a plurality of at-least-two-phase windings which are assembled one next to another around a soft-magnetic shaft; and an integrated magnet composed of a plurality of magnetic elements which are aligned one next to another in a manner such that poles of each of the magnetic elements are orientated to repel poles of its neighboring magnetic elements, wherein each magnetic element has a hollow space at the center thereof; wherein the integrated magnet and the coil are arranged in a manner such that the integrated magnet receives the coil, and the shape of the hollow space inside the integrated magnet directs the motion path of the coil or the integrated magnet.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the invention will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 shows a conventional reciprocating dynamo flashlight

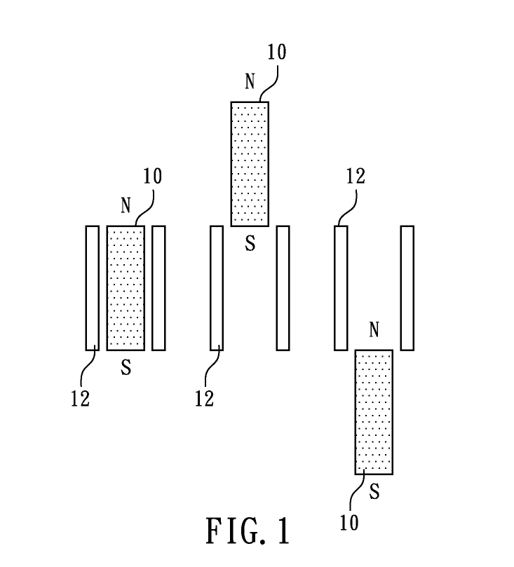

FIG. 2 is a schematic diagram illustrating the power generating principle of a reciprocating power generating module of the disclosure.

FIG. 3 is a schematic diagram showing a reciprocating power generating module according to an exemplary embodiment of the disclosure.

FIG. 4 is a schematic diagram of a reciprocating power generating module of another embodiment.

FIG. 5 is a schematic diagram of an embodiment for the integrated magnet column.

FIG. 6 is a schematic diagram showing a reciprocating power generating module according to a second embodiment of the disclosure.

FIG. 7 is a schematic diagram showing two reciprocating power generating modules of the disclosure used in an energy recovery device.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

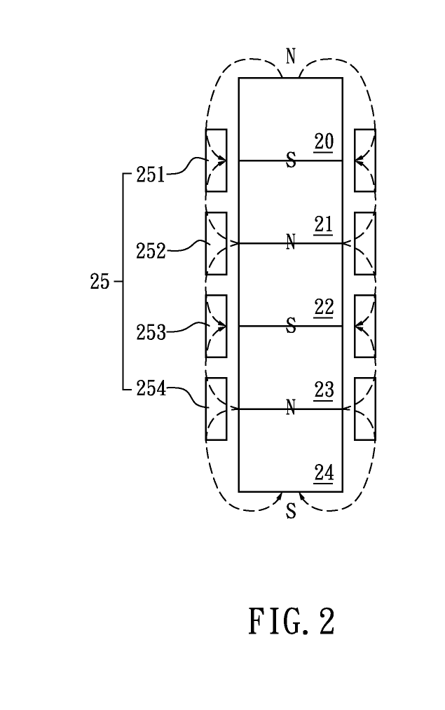

Please refer to FIG. 2, which is a schematic diagram illustrating the power generating principle of a reciprocating power generating module of the disclosure. In the reciprocating power generating module of FIG. 2, there are five anisotropic magnets 20, 21, 22, 23, 24 being connected with each other in a manner that poles of any one of the five magnets are orientated to repel poles of its neighboring magnets, i.e. the North pole of a magnet is disposed facing to the North pole of its neighboring magnet while enabling the South pole of its another neighboring magnet to be orientated to the South pole thereof. Moreover, a coil 25 composed of four sub-coils 251 to 254 is wound around the exterior of the concatenating magnets 20, 21, 22, 23, 24 in a series of alternating clockwise and counterclockwise loops, i.e. the winding direction of the sub-coil 251 is opposite to that of its neighboring sub-coil 252, and the winding direction of the sub-coil 252 is further opposite to that of its neighboring sub-coil 253, and furthermore the winding direction of the sub-coil 253 is opposite to that of its neighboring sub-coil 254.

By the aforesaid arrangement, the total length of magnet can be shortened comparing with that used in conventional reciprocating power generators and at the same time that the overall pole number can be increased. In addition, by stacking the magnets in the aforesaid repelling manner, the magnetic field lines are orientated in a direction perpendicular to the coil. Moreover, as the coil is winding in a multi-phase winding manner, the density of the coil is increased so that any minute relative movement between the magnets and the coil can be harvested and thus converted the relating magnetic field variation into the output electric power.

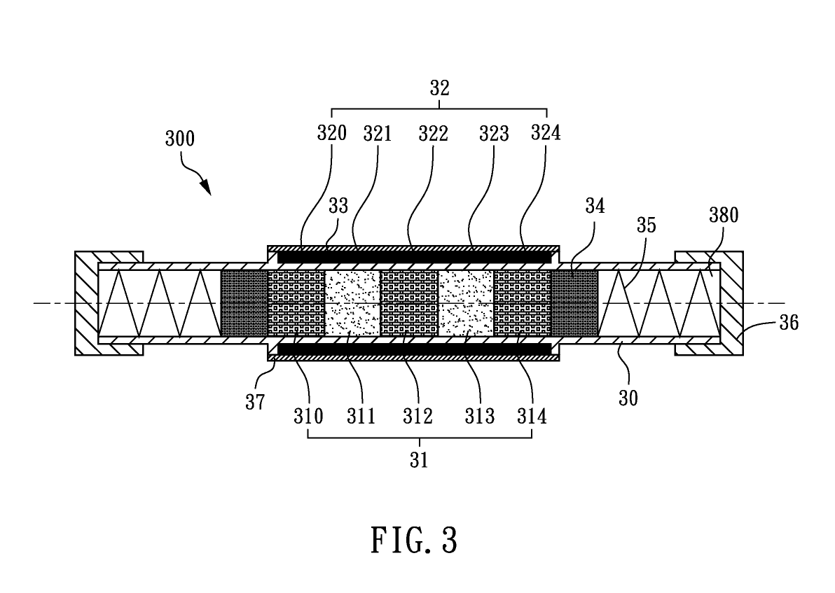

Please refer to FIG. 3, which is a schematic diagram showing a reciprocating power generating module according to a first embodiment of the disclosure. The reciprocating power generating module 300 includes an outer tube 30, a magnetic column 31, a coil 32, a yoke ring 33, weights 34, springs 35, end caps 36, and a back iron 37.

The outer tube 30 is a hollow tube having an accommodation space 380 formed therein along its center axis. The magnetic column 31 is composed of a plurality of anisotropic magnets 310 to 314 being connected with each other in a mutually repelling manner. The coil 32 composed of sub-coils 320 to 324 of n-phase winding is wound around the exterior of the outer tube 30 in a series of alternating clockwise and counterclockwise loops, wherein n is an integer larger than 1 and, in the embodiment, the coil 32 is composed of sub-coils of 3-phase winding. For example, the winding direction of the sub-coil 320 is opposite to that of its neighboring sub-coil 321, and the winding direction of the sub-coil 321 is further opposite to that of its neighboring sub-coil 322, and furthermore the winding direction of the sub-coil 322 is opposite to that of its neighboring sub-coil 323, and the winding direction of the sub-coil 323 is further opposite to that of its neighboring sub-coil 324, in which the sub-coils 320 to 324 are separated from each other by the use of the yoke rings 33 of soft magnetic, i.e., the yoke rings 33 are interposed between any two neighboring sub-coils 320 to 324 and surround the outer tube 30, so as to enhance the effect of magnetic flux variation upon the coil

The magnet column 31 and the coil 32 are arranged in a manner such that the magnet column 31 is received in the hollow space 380 inside the outer tube 30, and the shape of the inner surface of the outer tube 30 directs the motion path of the magnet column 31. For enabling the magnetic column 32 of the reciprocating power generating module 3 to perform a linear movement by the definition of the outer tube 30, the magnetic column 32 are attached by weights 34 at the two ends thereof. In addition, there are springs 35 being sandwiched between the weights 34 and their corresponding end caps 36 for exerting a resilience force upon the magnetic column 31 as it is performing the linear movement. In the exemplary embodiment shown in FIG. 3, for enhancing permeability, there is a back iron 37 being arranged outside the coil 32 while surrounding the same. Preferably, microgrooves can be formed on the inner surface of the outer tube 30 (not shown), so as to decrease the possibility of contact and thus decrease rubbing between the magnet column 31 and the inner surface. In the embodiment, the cross section of the magnetic column 31 and the coil 32 can be a circle, a regular hexagon, or other shapes which facilitate the linear movement of the magnetic column 31.

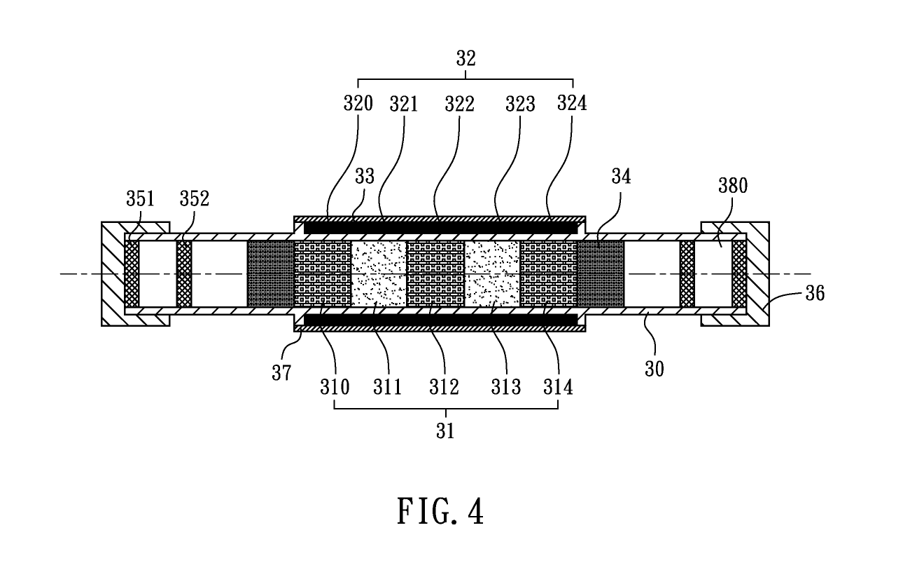

Moreover, except for arranging springs 35 between the magnet column 31 and the end caps 36 to obtain the resilience force, the springs 35 can be replaced by anisotropic magnets that are repelling to the magnetic column 31 to provide the elastic effect of the springs 35. Furthermore, a rope of high strength, such as a nylon line, may be strained tightly between both end caps 66 while an axial through via is formed in the magnet column 31, so that the integrated magnet 31 moves inside the outer tube 30 long the rope to perform the linear movement. Also, a magnetic force can be used to provide the similar effect of elasticity by the springs 35. FIG. 4 shows a schematic diagram of a reciprocating power generating module of another embodiment, with first magnets 351 bonded to the inner side surfaces of the end caps 36. The magnetic force between the magnet column 31 and the first magnets 351 can function as a buffer between the magnet column 31 and the first magnets 351 and rebound the magnet column 31, so that the magnet column 31 can move back and forth between the end caps. To facilitate a more flexible elastic effect in the movement of the magnet column 31, a floating magnet 352 is further provided in a position between the magnet column 31 and the first magnet 351.

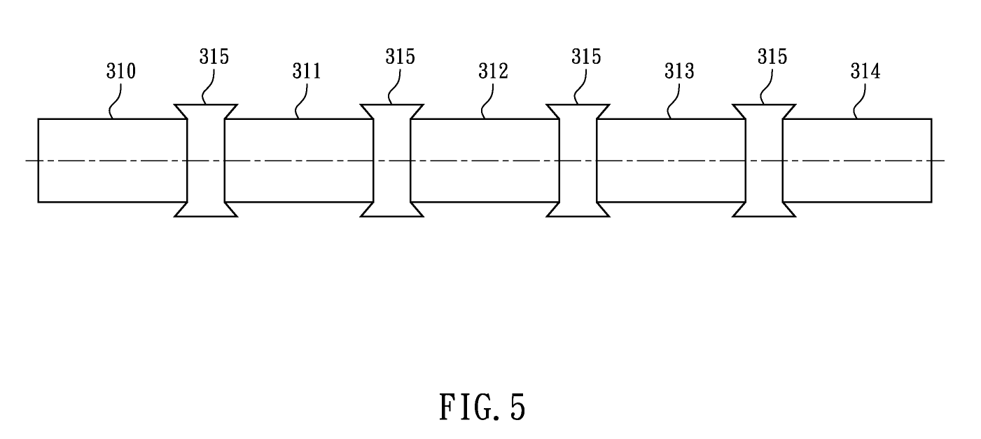

In another exemplary embodiment of the disclosure, the plural anisotropic magnets can be glued together or can be connected by screw rivets. In order to integrate or lock the magnets 310 to 314 to each other firmly to overcome the repelling magnetic force between the neighboring magnets 310 to 314, FIG. 5 demonstrates an embodiment for the integrated magnet column 31, wherein a fastening structure is formed on each side surface of each magnets 310 to 314 to lock or fasten each magnets 310 to 314. In the exemplary embodiment, ferromagnetic fastening interposers 315, which are larger than the magnets 310 to 314 in radius, are further disposed between any two neighboring magnets 310 to 314 to facilitate the distribution of the magnetic flux density inside the outer tube 30.

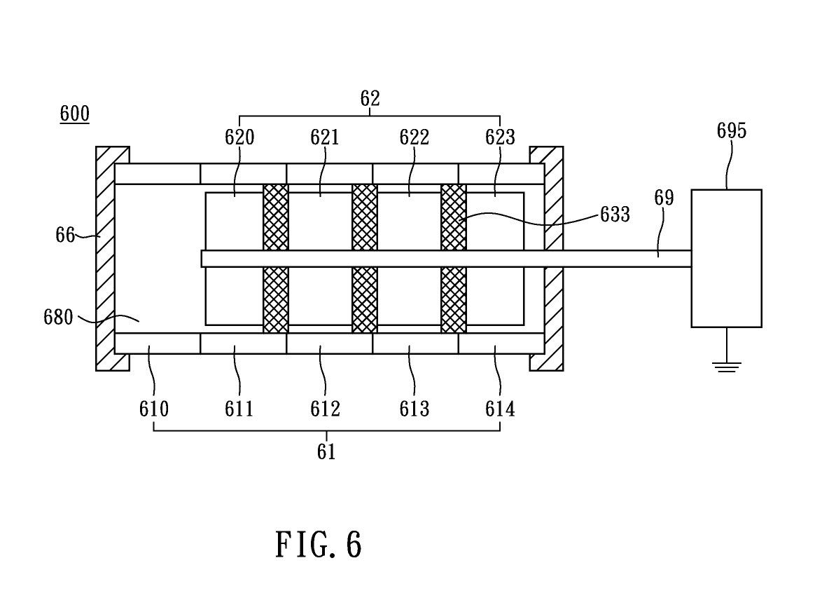

Please refer to FIG. 6, which is a schematic diagram showing a reciprocating power generating module according to a second embodiment of the disclosure. The reciprocating power generating module 600 includes an integrated magnet 61, a coil 62, and end caps 66. The coil 62 is composed of four sub-coils 620 to 623 of 3-phase winding which are assembled one next to another around a soft-magnetic shaft 69.

The integrated magnet 61 is composed of five magnetic elements 610 to 614 which are aligned one next to another in a manner such that poles of each of the magnetic elements 610 to 614 are orientated to repel poles of its neighboring magnetic elements, wherein each magnetic element has a hollow space 680 at the center thereof. The integrated magnet 61 and the coil 62 are arranged in a manner such that the integrated magnet 61 receives the coil 62. The shape of the hollow space 680 inside the integrated magnet 61 directs the motion path of either the coil 62 or the integrated magnet 61, depending on that either the integrated magnet 61 is fixed while the coil 62 is movable or the coil 62 is fixed while the integrated magnet 61 is movable. As shown in FIG. 6, a hole is formed at the center of one of the end caps 66 to allow the shaft 69 to match and penetrate through. The shaft 69 is ground or fixed to a fixer 695, so that the inner coil 62 is fixed while the outer integrated magnet 61 moves along the direction of the shaft 69 axis. Moreover, springs may be used to connect the integrated coil 62 and the end caps 66 to exert a resilience force upon the coil 62 as it is performing the linear movement. Also, a high-strength nylon rope may be strained tightly between both end caps 66 while an axial through via is formed in the integrated coil 62, so that the coil 62 moves inside the integrated magnet 61 long the rope to perform the linear movement. In the embodiment, the cross section of the integrated magnet 61 and the coil 62 can be a circle, a regular hexagon, or other shapes which facilitate the linear movement.

In order to integrate the magnets 610 to 614 firmly into the integrated magnet 61 and to overcome the repelling magnetic force between the neighboring magnets 610 to 614, a fastening structure is formed on each side surface of each magnetic element so as to lock the neighboring magnets 610 to 614 to each other. And to make the magnetic flux density well-distributed inside the outer tube, a ferromagnetic fastening interposer is further disposed between any two neighboring magnets 310 to 314. Furthermore, as shown in FIG. 6, soft-magnetic parts 633, which are larger than the sub-coils 620 to 623 in radius, are interposed between any two neighboring sub-coils 620 to 623 so as to enhance the effect of magnetic flux variation upon the coil 62.

Under the aforesaid arrangement, a voltage peak can be generated as soon as the relative displacement between the magnetic column 31 and the coil 32 reaches and equal to the length of a single anisotropic magnet, whereby the path traveling by the mover, i.e. the magnetic column 31, can be shortened to one third or one fifth of those required in prior art for achieving instant maximum output voltage.

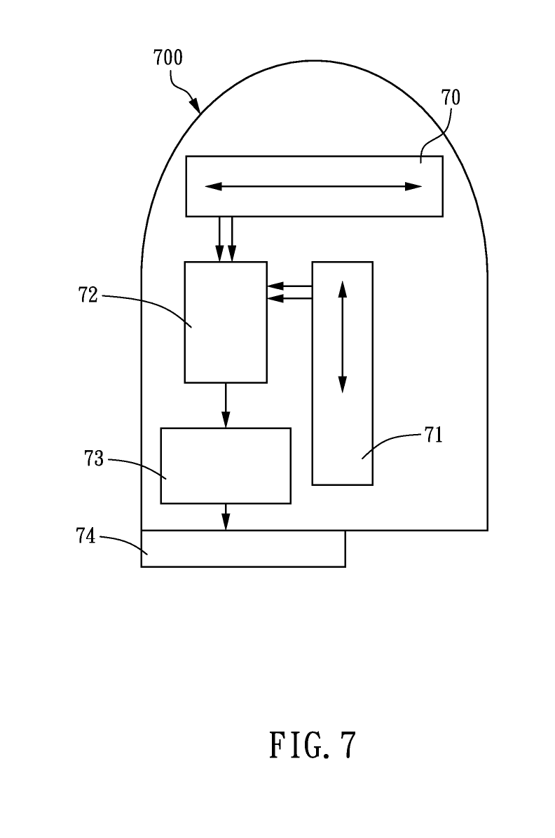

Accordingly, the aforesaid reciprocating power generating module can be adapted as an energy recovery device for recycling energy of a one-dimensional, a two-dimensional, or a three-dimensional movement. As the two-dimensional movement energy recovery device 700 shown in FIG. 7, it is configured with two aforesaid reciprocating power generating modules 70, 71 that are arranged perpendicular to each other and connected respectively to a rectification regulator 72. As the rectification regulator 72 is further connected to a battery 73 which can be a charging capacitor or a secondary battery, the power generated by the two reciprocating power generating modules 70, 71 is stored in the battery 73. In FIG. 7, the battery 73 is further electrically connected to a load 74 or a socket.

Comparing with those conventional reciprocating power generating modules, the advantages of the present disclosure is listed as following:
(1) As the magnets used in the reciprocating power generating module of the disclosure is arranged in the aforesaid repelling manner and the coil is wound in a series of alternating clockwise and counterclockwise loops, it is able to generate several voltage during the magnet is performing a reciprocating movement about the coil so that it can generate power with comparatively smaller relative displacement; moreover, by the stacking of more than two magnets or have more than three odd numbered magnets, the flux path is shortened for reducing distance between poles and enhancing surface magnet flux density so that the output energy density is increased.
(2) Generally, as the coil in most common motors adopts multi-pole winding that there are gaps between any two neighboring sub-coils and will result lower coil density, such multi-pole winding is not suitable for mini-sized reciprocating power generators. Nevertheless, the coil in the present disclosure is wound in a series of alternating clockwise and counterclockwise loops, not only it can achieve a higher coil density, but also the induced electromotive force of each sub-coil is in phase synchronization that can be serially connected in a simple and reliable manner.
(3) As the magnetic intensity of the isotropic magnets is weak that when it is adopted as the magnet of the disclosure for forming the aforesaid flux path, apparently, the energy density can not be satisfactorily increased. Thus, by adopting anisotropic magnets while stacking the same in the aforesaid repelling manner, the surface magnetic field distribution can be optimized for enabling the coil to have the best cutting effect as the magnet is moving relative to the coil.

It is noted that the coil used in the disclosure can be formed by injection molding so that it can do without an independent guide tube as the coil is integrally formed therewith. Thereby, the magnet can be guided to move by the defining of the inner surface or the outer surface of the integral-formed outer tube. Moreover, the cross section of the outer tube can be shaped like a circle, a square, or other polygons that is selected as required by users only if it is able to guide the magnet to move smoothly relative to the coil. In addition, for reducing the friction and the noise caused by the contact between the magnet and the outer tube as the magnet is moving relative to the coil, the contact surface between the magnet and the outer tube is surface processed or is configured with a micro-groove structure. In an exemplary embodiment of the disclosure, the width of each cell provided for sub-coil to wind upon can be equal or not equal to any single magnetic element used in the disclosure. In addition, there can be magnetic materials to be disposed at positions between any two neighboring magnetic elements to be used for altering the type of flux path; and there also can be magnetic materials to be disposed at positions between any two neighboring sub-coils for enhancing the affection of magnetic flux variation upon the coil.

In another exemplary embodiment of the disclosure, the springs arranged at the two ends of the outer tube can be replaced by buffering members, such as rubber, soft plastic, or other elastic polymers with buffering ability. It is noted that it is possible to place a spring at one end of the outer tube while placing a buffering member at the other end.

When there are more than two reciprocating power generating modules of the disclosure are used in a device in a manner that they are arranged parallel to each other, the movers of the two parallel-arranged reciprocating power generating modules can be connected by the use of a rigid structure for synchronizing their movement. However, when they are configured in a system that is not move linearly, the more than two reciprocating power generating modules can be arranged in a manner that they are not parallelized with each other and thus to be used as kinetic energy recovery device.

From the above description, it is noted that the reciprocating power generating module of the disclosure can be driven by any pneumatic device or hydraulic device, such as a piston-rod tidal generator. Moreover, as the present disclosure is able to utilize the mass of its mover to absorb kinetic energy, it can be adapted for portable electronic devices, such as computer mouse or accessories of gaming consoles and used as the primary structure of a power generating unit.

The disclosure being thus described, it will be obvious that the same may be varied in many ways. Such variations are not to be regarded as a departure from the spirit and scope of the disclosure, and all such modifications as would be obvious to one skilled in the art are intended to be included within the scope of the following claims.

What is claimed is:

1. A reciprocating power generating module comprising:
a guide having a hollow space along the center axis thereof;
an integrated magnet composed of a plurality of magnetic elements which are aligned one next to another in a manner such that poles of each of the magnetic elements are orientated to repel poles of its neighboring magnetic elements; and
a coil composed of a plurality of at-least-two-phase windings which are wound around the guide and integrated one winding next to another;
wherein the integrated magnet and the coil are arranged in a manner such that the coil is received in the hollow space inside the guide, and the shape of the inner surface of the guide directs the motion path of the integrated magnet.

2. A reciprocating power generating module of claim 1, wherein a plurality of microgrooves are formed on the inner surface of the guide.

3. A reciprocating power generating module of claim 1, wherein the guide comprises two end caps respectively at the ends of the guide.

4. A reciprocating power generating module of claim 3, wherein a spring is disposed between the integrated magnet and one of the end caps.

5. A reciprocating power generating module of claim 3, wherein a rope of high strength is strained between both end caps.

6. A reciprocating power generating module of claim 3, wherein a first magnet is bonded to the inner side surface of the end cap.

7. A reciprocating power generating module of claim 6, wherein a second magnet is floating between the integrated magnet and the first magnet.

8. A reciprocating power generating module of claim 1, wherein a fastening structure is formed on each side surface of each magnetic element so as to lock the neighboring magnetic elements firmly.

9. A reciprocating power generating module of claim 1, wherein a ferromagnetic part is interposed between any two neighboring magnetic elements.

10. A reciprocating power generating module of claim 9, wherein the ferromagnetic part is larger than the magnetic elements in radius.

11. A reciprocating power generating module of claim 1, wherein a soft-magnetic part interposed between any two neighboring windings so as to enhance the effect of magnetic flux variation upon the coil.

12. A reciprocating power generating module comprising:
a coil composed of a plurality of at-least-two-phase windings which are assembled one next to another around a soft-magnetic shaft; and
an integrated magnet composed of a plurality of magnetic elements which are aligned one next to another in a manner such that poles of each of the magnetic elements are orientated to repel poles of its neighboring magnetic elements, wherein each magnetic element has a hollow space at the center thereof;
wherein the integrated magnet and the coil are arranged in a manner such that the integrated magnet receives the coil, and the shape of the hollow space inside the integrated magnet directs the motion path of the coil or the integrated magnet.

13. A reciprocating power generating module of claim 12, wherein a fastening structure is formed on each side surface of each magnetic element so as to integrate the neighboring magnetic elements firmly.

14. A reciprocating power generating module of claim 13, wherein a ferromagnetic interposer is disposed between any two neighboring magnetic elements.

15. A reciprocating power generating module of claim 12, wherein a soft-magnetic part is interposed between any two neighboring windings so as to enhance the effect of magnetic flux variation upon the coil.

16. A reciprocating power generating module of claim 15, wherein the soft-magnetic part is larger than the windings in radius.
